(19) United States
(12) Patent Application Publication
(10) Pub. No.: US 2005/0152275 A1
(43) Pub. Date: Jul. 14, 2005

(54) Method, system, and network element for monitoring of both session content and signalling information in networks

(75) Inventors: Antti K. Laurila, Tampere (FI); Toni Maki, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/801,641

(22) Filed: Mar. 17, 2004

(30) Foreign Application Priority Data
Jan. 14, 2004 (EP) 04000607.4

(51) Int. Cl. H04L 12/26

(52) U.S. Cl. 370/241; 370/401; 709/224

(57) ABSTRACT

The invention provides a method and system for intercepting at least one session involving at least a first and a second network of different types. For interception both signalling information of the at least one session, and session content related to the same session provided in another of the first and second networks are monitored. An indication to start interception is delivered from one of the first and second networks to the other one of the first and second networks. The first network can be an IP Multimedia Subsystem, IMS, network, and the second network a General Packet Radio Service, GPRS, network.

### FIELD AND BACKGROUND OF THE INVENTION

The present invention relates to a method, system, and network element or apparatus for performing lawful interception in e.g. an IP multimedia subsystem (IMS) of a network such as a UMTS, Universal Mobile Telecommunication System, network. In particular, the invention relates to a method and apparatus for monitoring of both session content and signalling information in networks of different types such as IP based networks and GPRS or UMTS based networks.

Conventionally, Lawful interception of GPRS IRI (General Packet Radio Service, Interception Related Information) and GPRS CC (Content of Communication) may be activated using GPRS domain user identities (IMSI, MSISDN, and IMEI) as target criterion in GPRS Support Node(s). Call State Control Function(s), CSCF(s), cannot perform interception based on these triggers. Currently IMS IRI may be collected using separate IMS interception started with SIP URL or TEL URL (URL=Universal Resource Locator) as a target criterion.

WO 02/093838 discloses a method and communication system allowing interception of a connection of a target to be intercepted. Interception triggering information may be transmitted between the user plane and control plane. When a connection is to be intercepted, a control means handling signalling of the connection that generates interception information for informing a support element transmitting the traffic on an identification of the target to be intercepted. In response thereto, the support element copies the traffic information to another network element for interception.

### SUMMARY OF THE INVENTION

It is an object of the present invention to provide a method and apparatus by means of which Lawful Interception can be improved.

This object is achieved by a method as defined in the independent method claims.

Additionally, the above object is achieved by a system as defined in the independent system claims.

Further, there is provided a network element as defined in the network element claims.

Some advantageous implementation features are defined in the dependent claims.

The invention provides monitoring of both session content (Content of Communications, CC, that is data transmitted between communicating parties) and signalling information in networks such as IMS networks based on one identity e.g. either in GPRS or any other IP connectivity network, or IMS level.

According to an aspect of the invention, there are provided method and system for sending lawful interception information from an element or function of a network, such as a Call State Control Function, CSCF, to one or more elements or functions, for example GPRS Support Nodes, GSNs, of another network to activate also the monitoring of content of communication based on IMS level triggers. The content of communication can thus be intercepted based on IMS level identities (e.g. SIP URI defined in RFC 3261, TEL URI defined in RFC 2806 or general URI as in RFC 2396) and it is not necessary to use a separate GPRS level activation based on different GPRS level identities that the target might have (International Mobile Subscriber Identity, IMSI; Mobile Subscriber ISDN Number, MSISDN; International Mobile Equipment Identity, IMEI).

With this invention it is possible for Law Enforcement Agencies, LEAs, to get also the content of session with only one identity, and, if desired, to map it together with IMS level IRI (IRI=Interception Related Information, such as Signalling Information from Session Initiation Protocol, SIP, messages).

This kind of solution is useful e.g. in a multi-vendor network where a GPRS backbone is from a different vendor than the IMS network. The invention is also directly applicable for other backbones such as 3GPP2 (3G Partnership Project 2) based IMS networks or WLANs, Wireless Local Area Networks.

The invention further provides, according to another or additional aspect, a method for activating the IRI interception in the IMS domain based on GPRS domain triggering. Such a method solves the same problem as described above, but in reverse direction. With this method it is possible for the LEAs to get also the IMS IRI using only GPRS level identities (IMSI, MSISDN, IMEI).

### BRIEF DESCRIPTION OF THE DRAWINGS

In the following, the invention will be described in greater detail on the basis of a preferred embodiment with reference to the accompanying drawings.

FIG. 1 shows an embodiment of a configuration for lawful interception in IMS networks,

FIG. 2 shows a further embodiment of a configuration for lawful interception in IMS networks,

FIG. 3 shows another embodiment of a configuration for lawful interception in IMS networks,

FIG. 4 shows a flow diagram of signalling during media authorization according to an embodiment of the present invention, and

FIG. 5 shows a flow diagram of signalling during media authorization according to another embodiment of the present invention.

### DESCRIPTION OF PREFERRED EMBODIMENTS

The below described embodiments of the invention provide methods and systems or devices for monitoring session content in IP Multimedia Subsystem, IMS, core networks. Methods and systems are disclosed for carrying information for starting interception from GSN to CSCF(s) where the IMS IRI is available. The decision of interception is preferably done for every session created in IMS. According to at least one of the preferred embodiments, a Call State Control Function, CSCF, of IMS sends Lawful Interception, LI, information either directly to a GPRS Support Node, GSN, to Administration Function, ADMF, or to Delivery Function 2, DF2.

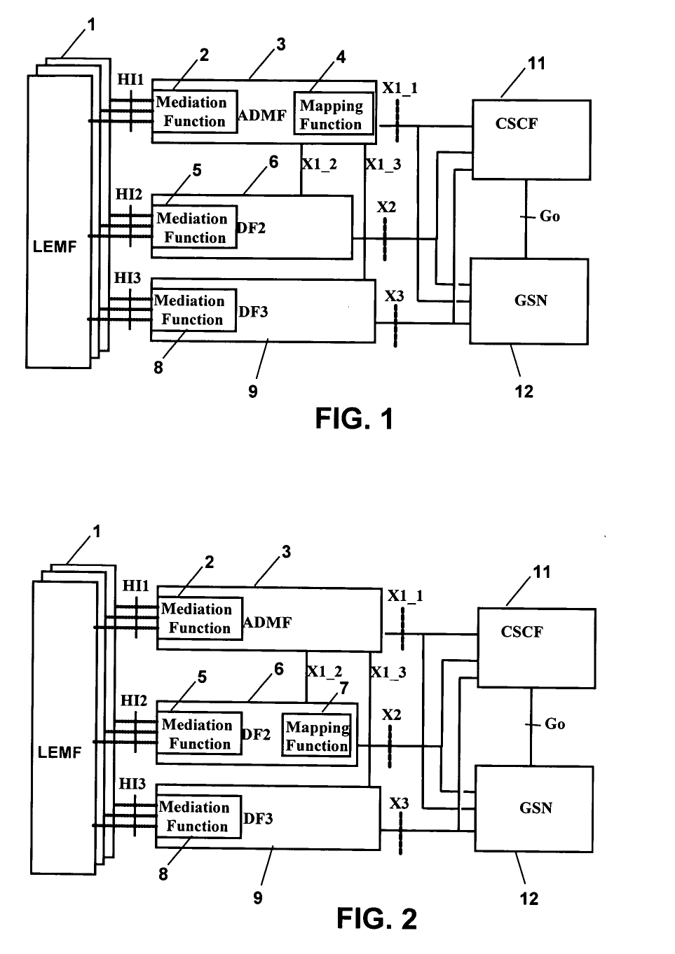

FIG. 1 shows an embodiment of the invention providing a reference configuration or architecture for lawful interception in IMS networks. Conventionally IMS LI and GPRS LI architectures were totally separated although they could use some same elements, that is, ADMF and DF2.

The embodiment of FIG. 1 includes, or cooperates with, one or more Law Enforcement Monitoring Facilities, LEMFs, 1 which are connected or connectable to an Administration Function, ADMF, 3 via an interface HI1. ADMF 3 comprises a mediation function 2 and a mapping function 4. The ADMF 3 is connected or connectable to a Call State Control Function, CSCF, 11, and a GPRS Support Node, GSN, 12 via an interface X1_1. The GSN 12 may e.g. be a Serving GPRS Support Node, SGSN, and/or Gateway GPRS Support Node, GGSN.

The LEMFs 1 are further connected or connectable to a Delivery Function 2, DF2, 6 via an interface H12. DF2 6 comprises a mediation function 5. The DF2 6 is connected or connectable to the Call State Control Function, CSCF, 11, and the GSN 12 via an interface X2.

The LEMFs 1 may further be connected or connectable to a Delivery Function 3, DF3, 9 via an interface H13. DF3 9 comprises a mediation function 8. The DF3 9 is connected or connectable to the Call State Control Function, CSCF, 11, and the GSN 12 via an interface X3.

The ADMF 3 is preferably connected or connectable to the DF2, 6 via an interface X1_2. Further, the ADMF 3 is preferably connected or connectable to the DF3, 9 via an interface X1_3.

The Administration Function, ADMF, is thus able to communicate with the Delivery Function 2, DF2, and/or the Delivery Function 3, DF3.

FIG. 2 shows a further embodiment of the invention providing a reference configuration or architecture for lawful interception in IMS networks. The embodiment of FIG. 2 is similar to the embodiment of FIG. 1 except that the DF2 6 includes a mapping function 7. ADMF 3 does not include, in this embodiment, a mapping function 4. Apart from these changes, the above description of FIG. 1 also applies to the embodiment of FIG. 2.

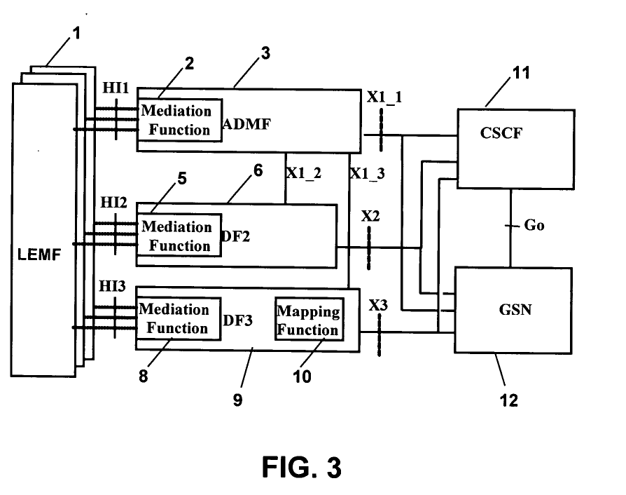

FIG. 3 shows another embodiment of the invention providing a reference configuration or architecture for lawful interception in IMS networks. The embodiment of FIG. 3 is similar to the embodiments of FIGS. 1 and 2, except that the DF3 9 includes a mapping function 10. ADMF 3 does not include, in this embodiment, a mapping function 4. Apart from these changes, the above description of FIG. 1 also applies to the embodiment of FIG. 3.

The CSCF 11 and the GSN 12 are connected or connectable to each other via an interface Go.

According to FIGS. 1 to 3, a Mapping Function 4, 7, 10 is provided for ADMF 3, DF2 6, or DF3 10. In alternative embodiments, two or three of these Mapping Functions may be provided so that Mapping Functions are present in ADMF 3 and DF2 6, or in ADMF 3 and DF3 9, or in DF2 6 and DF3 9, or in ADMF 3, DF2 6, and DF3 9.

When GPRS level interception is desired to be started from the indication at the IMS level (e.g. at the time of IMS session establishment), the information of matching triggers in IMS level has to be forwarded to General Packet Radio Service, GPRS, e.g. to GSN 12, by using identities that are known in GPRS, such as International Mobile Subscriber Identity, IMSI, or GPRS Charging Identifier, GCID+GGSN ID pair. If the ADMF 3 is included in the signalling path, it may command the GSN 12 to start the interception. LI information delivered from IMS, e.g. CSCF 11, to GPRS, e.g. GSN 12, may consist of IMS domain user identifiers, IMS domain session identifiers (ICID (IMS Charging Identifier), Call-ID, Authorization Token), GPRS domain user identifiers (IMSI, MSISDN, IMEI), GPRS domain session identifiers (GCID+GGSN ID pair, TID) (GCID=GPRS Charging Identifier; TID=Tunnel Identifier), and/or lawful interception parameters (LIID (Lawful Interception Identifier), Delivery Function addressing information, type of interception). By using at least one, or some or all of these, or other, identifiers GPRS may perform CC interception. Which identifiers are used may depend on the embodiments used. The invention offers several different embodiments for delivering an indication to start interception from the IMS domain to the GPRS domain.

Session content exists in the GPRS level, but the interception triggers of the IMS networks are normally not visible in GPRS level, they are visible only in the IMS, e.g. in CSCFs of IMS.

LI Triggers of the IMS networks defined so far are SIP_URL and/or TEL_URL (URL=Universal Resource Locator). GPRS domain information (identities) associated with the LI triggers of the IMS, that can be used in interception in GPRS level may vary between sessions established in IMS. For example, the user in IMS may use different terminal than used in previous IMS session when starting a new IMS session.

Therefore the decision of interception is preferably done for every session created in IMS. If desired by the LEA, the decision of interception may remain after the appropriate session has been terminated in IMS. Thus, the decision of interception issued for a session created in the first network, e.g. IMS, is maintained in the first network after termination of this session for use for at least one following session. Hence, the decision of interception is used for at least two sessions, and there is no need to decide again on the question of interception for a new session. IMS domain session information intercepted with IMS domain triggers in IMS domain is preferably forwarded to GPRS so that GPRS can perform CC monitoring. The CSCF 11 of IMS may send LI information either directly to GSN 12 (e.g. Serving GPRS Support Node, SGSN, and/or Gateway GPRS Support Node, GGSN) over Go interface (TS 29.207 V5.5.1), or to ADMF 3 over X1_1 interface, or to DF2 6 over X2 interface.

Some embodiments of the invention also incorporate a reverse operation. A method and system for activating the IRI monitoring in IMS level may be employed when the interception is originally activated using GPRS domain target identifiers (IMSI, MSISDN, International Mobile Equipment Identity, IMEI). In this method and system, GPRS domain, e.g. GSN 12, examines the transmitted information to/from the intercepted target. The device that performs the data analysis can be either GSN 12 or Delivery Function 3, DF3, 9. When it is noticed that the data contains SIP header(s), the identities are preferably extracted from To and/or From fields of SIP header.

If GSN 12 is performing the data examining, it sends LI information either directly to CSCF 11 over Go interface or to ADMF 3 over X1_1 interface. If DF3 9 is performing the data analysis, it sends LI information either directly to CSCF 11 over X3 interface or to ADMF 3 over X1_3 interface.

When the ADMF 3 is included in the signalling path, it may explicitly command CSCF 11 to start the interception. LI information delivered from GPRS to IMS may consist of IMS domain user identifiers, IMS domain session identifiers (ICID, Call-ID, Authorization Token), GPRS domain user identifiers (IMSI, MSISDN, IMEI), GPRS domain session identifiers (GCID+GGSN ID pair, TID), and/or lawful interception parameters (LIID, Delivery Function addressing information, type of interception).

Lawful interception of IMS IRI is always activated using IMS domain user identities as target criterion in Serving-CSCF, S-CSCF or in Proxy-CSCF, P-CSCF (SIP_URL and TEL_URL). GSN(s) cannot perform interception based on these target criterions. In accordance with embodiments of the invention, information indicating the need of LI activation can be carried from CSCF 111 to GSN(s) 12 where actual IMS session related content of communication is present. Thus IMS session related content of communication can be monitored.

The invention offers several solutions how the indication to start interception may be delivered from IMS domain to GPRS domain.

In the following, several embodiments are described which provide solutions with GPRS interception activation initiated by IMS based on LI download over Go interface Embodiment 1.). According to a first embodiment, LI information is sent from CSCF 11 (or more precisely a Policy Decision Function, PDF, of P-CSCF) to GSN 12 over Go-interface together. The indication to intercept is delivered from CSCF 11 (or PDF) to GSN 12 during the media authorization. The structure of this embodiment 1.) and of all further embodiments may be in accordance with anyone of FIGS. 1 to 3, or any arbitrary combination thereof, or a structure without a mapping function, unless otherwise stated below.

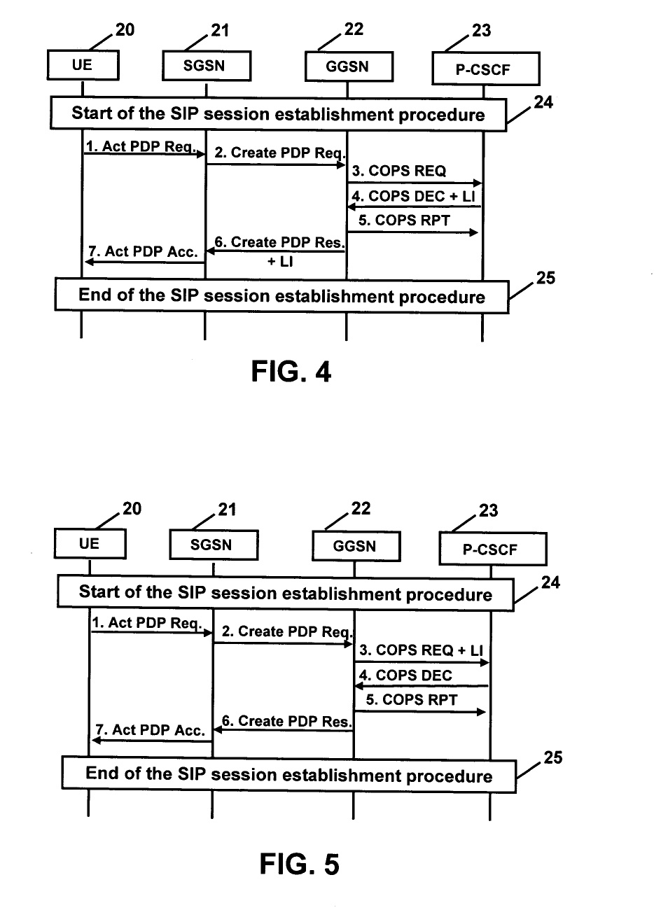

FIG. 4 shows the signalling during media authorization. According to FIG. 4, a User Equipment, UE, 20, a SGSN 21, a GGSN 22, and a Proxy Call State Control Function, P-CSCF, 23 are provided. The P-CSCF 23 may correspond to, or be identical with, CSCF 11 of FIGS. 1 to 3. The SGSN 21 or the GGSN 22 may correspond to, or be identical with, GSN 11 of FIGS. 1 to 3.

According to FIG. 4, a procedure 24 for starting a SIP session establishment is carried out. This “Start of the SIP session establishment procedure” 24 includes the conventional SIP messaging before media reservation. Subsequent to the procedure 24, media reservation is carried out in accordance with messages 1. to 7., as shown in FIG. 4. In message 1., an Activate PDP Context Request is sent from UE 20 to SGSN 21. The SGSN 21 delivers a message 2., Create PDP Context Request, to GGSN 22. The GGSN 22 sends a message 3., COPS REQ, to P-CSCF 23 which responds by sending a message 4., COPS DEC+LI (COPS=Common Open Policy Service Protocol; LI=Lawful Interception indication or parameter), to GGSN 22. The GGSN 22 returns a message 5., COPS RPT, to P-CSCF 23, and sends a message 6., Create PDP Context Response+LI, to SGSN 21. In a step 7., the SGSN 21 transmits a message 7., Activate PDP Context Accept, to the UE 20. A subsequent procedure 25, “End of the SIP session establishment procedure”, includes the conventional SIP messaging after media reservation. The procedure of establishing the SIP Session is thus ended.

The indication to intercept is delivered in the message 4., COPS DEC, (decision message of COPS, Common Open Policy Service Protocol) of FIG. 4. When the GGSN 22 asks for authorization of the PDP context, it receives the LI information with the authorization decision. This method is appropriate, and fits well to the purpose of Go interface. Thus adapting the Go interface because of the LI is easy. The LI information sent in the COPS DEC message preferably consists of IMS domain target criterion (e.g. SIP_URL or TEL_URL), LI parameters (e.g. LIID, DF3 address and type of interception), and/or IMS domain session identifiers (e.g. ICID, Call-ID, or Authorization Token) or GPRS domain session identifiers (e.g. GCID+GGSN address pair or TID).

When GGSN 22 receives this message it can start the interception of the content of communication related to the IMS session. It also has to deliver the information to SGSN 21. The GGSN 22 does this by attaching the LI information it received from (PDF of) P-CSCF 23 to the Create PDP Context Response message 6. that is sent as a response to Create PDP Context Request message. The GGSN 22 sends the Create PDP Context Response message to the SGSN 21, which in turn can start the interception of content of communication related to IMS session.

Because the SGSN 21 of the monitored user may change due to inter-SGSN handover, the LI information is transferred to the new SGSN 21. During the inter-SGSN handover, the new SGSN requests active PDP contexts from the old SGSN. The new SGSN sends old SGSN a SGSN Context Request message, and the old SGSN responds with a SGSN Context Response message. Now, if there is an active IMS session related content of communication interception, the old SGSN attaches the LI information to the SGSN Context Response. In this way the new SGSN may start the interception of content of communication related to the monitored IMS session. In the case of inter-operator handover, the old SGSN may or may not send the LI information to the new SGSN.

Embodiment 2.). In this solution, the ADMF 3 takes care of the actual interception activation in all the network elements over the X1_1 interfaces. It gives the CSCF(s) 11 and SGSNs/GGSNs 12 the same LI information. The LI information in this embodiment consists of the IMS domain target criterion (SIP_URL or TEL_URL) and lawful interception parameters (LIID, DF2/DF3 address, type of interception). Because the GSN 12 cannot activate the interception using IMS domain target criterion, the interception is stored in GSN 12 in semi-active state. Like in the above described embodiment 1, the indication to intercept is delivered from the CSCF 11 (PDF) to GSN 12 during the media authorization. The indication to intercept is delivered in COPS DEC message (message 4. of FIG. 4). A difference of this embodiment 2.) to the embodiment 1.) is that CSCF 11 (PDF) needs to include only an indication of the interception need in the authorization decision. This is because the other information is already present in the GSN 12 in the semi-active interception after the initial activation. LI information sent with COPS DEC message 4. may be the used IMS domain target criterion. In this embodiment, the ADMF 3 takes the responsibility of delivering and activating the LI in GSNs 12.

The LI indication is delivered from GGSN 22 to SGSN 21 in Create PDP Context Response message 6. like in embodiment 1. The LI information attached into the Create PDP Context Response message may be the used IMS domain target criterion. As with the GGSN 22 the other information is already present in the SGSN 21 after the initial activation.

Like in embodiment 1.), also in this embodiment 2.) the chance of inter-SGSN handover is considered. The method for delivering the LI indication between SGSNs is similar to that in the embodiment 1.). The LI information inserted into SGSN Context Response message consists of the same information that the old SGSN received in the Create PDP Context Response message from the GGSN. That is, for example the IMS domain target criterion. In the case of inter-operator handover, the old SGSN may send the LI information to the new SGSN. The fact that whether the interception is continued in the new operator's network or not, is decided by the independent activation done or not done in the new operator's network.

Embodiment 3.). The embodiment 3.) provides a solution for activation of GPRS interception initiated by IMS in which DF2 holds the activation responsibility.

In this embodiment 3.), the LI information is sent from CSCF 11 to DF2 6, or to the Mediation Function 5 of DF2 6, over the X2 interface. DF2 6 or the Mediation Function 5 of DF2 6 then sends the LI information to the GSN 12 over the X2 interface. The LI information sent over the X2 interfaces may consist of IMS domain target criterion (SIP_URL or TEL_URL), IMS domain session identifiers (ICID, Call-ID, Authorisation Token), and/or GPRS domain session identifiers (GCID+GGSN address pair(s)). As X2, X3 interfaces are standardized, the embodiment complies with current LI architecture, and simply adds a new directional data flow over X2 interface, that is, the LI information sent from DF2 6 to GSN 12.

The following embodiments 4.), 5.) provide an activation of GPRS interception initiated by IMS and based on mapping of IMS identity to GPRS identity.

Embodiment 4.). An aspect in this embodiment is to use a new Mapping Function. The task of the new Mapping Function is to translate the IMS domain target criterion (SIP_URL or TEL_URL) to the corresponding GPRS domain target criterion (IMSI, MSISDN, IMEI) associated with the same monitored user (and vice versa). The association between IMS domain target criterion and GPRS domain target criterion may be static or dynamic.

The Mapping Function 4 in ADMF 3 shown in FIG. 1 receives LI information related to GPRS domain session (PDP context) from the GSN 12 over the X1_1 interface when the GPRS domain session is started (PDP context activated). The Mapping Function 4 may receive this LI information either asynchronously without querying it, or as a result of an explicit query. The LI information related to GPRS domain session consists of GPRS domain session identifiers (e.g. GCID+GGSN address, TID) and/or GPRS domain user identities (IMSI, MSISDN, IMEI).

The Mapping Function 4 in ADMF 3 receives IMS domain session identifiers from the CSCF 11 over the X1_1 interface when the IMS domain session is started (session started with SIP INVITE method). The Mapping Function 4 receives this LI information asynchronously without querying it. The LI information related to IMS domain session consists of IMS domain session identifiers (e.g. ICID, Call-ID, Authorization Token) and GPRS domain session identifiers (e.g. GCID+GGSN address, TID) of the GPRS domain session related to the IMS domain session of the monitored user.

When the Mapping function 4 receives the LI information from CSCF 11 via the X1_1 interface, it extracts the GPRS domain session identifiers and queries its internal cache.

If the cache contains binding information which indicates binding between GPRS domain session identifier and GPRS domain user identity, related to the GPRS domain session identifier received in LI information from CSCF, the ADMF 3 may command GSN 12 to start interception of content of communications in GPRS domain. If no hit is found in the cache, the Mapping Function 4 of ADMF 3 may query the GSNs 12. It includes the GPRS domain session identifier(s) to the query message and sends a copy of query message to GSN 12. Query message is sent to all SGSNs 21. The Mapping Function 4 of ADMF 3 may choose to send the query message to all of the GGSNs 22 or only to the GGSN 22 identified by the GPRS domain session identifiers, if the appropriate GGSN 22 is known to ADMF 3.

The Mapping Function 4 of ADMF 3 expects to receive GPRS domain user identity as a response to the query. When the Mapping Function 4 of ADMF 3 knows the GPRS domain user identity related to the IMS domain session associated with the monitored user, ADMF 3 may use the known user identity as GPRS domain target criterion.

Embodiment 5.). This embodiment 5.) is similar to the embodiment 4.), except that the Mapping Function 7 is located in DF2 6, as shown in FIG. 2. In this embodiment 5.), the CSCF 11 and GSN 12 send the LI information with needed IDs over the X2 interface to the Mapping Function(s) 7. Also the Mapping Function 7 commands the GSN 12 to start interception of content of communications using the X2 interface.

In the following several embodiments are described which provide for collecting IMS IRI with only one interception activation using GPRS identifiers as target criterion.

The below described embodiments 6.) to 8.) provide an activation of IMS interception initiated by GPRS based on examination of GPRS CC.

Embodiment 6.). Before IMS UE 20 can perform e.g. the SIP REGISTER method when attached to GPRS, it has to activate at least one PDP context. The SIP REGISTER message is then transferred through GPRS network as content of communications, CC. When there is an interception activated with GPRS domain target criterion (IMSI, MSISDN, INMI), the DF3 9 receives the data containing the SIP message (SIP REGISTER in this case) via X3 interface from GSN 12, e.g. from SGSN 21 and/or GGSN 22. DF3 9 then checks whether the data contains SIP header and whether the SIP header contains SIP URL or TEL URL. If a URL is found in data, the DF3 9 may forward LI information to the Mapping Function 4 of ADMF 3 via the X1_3 interface, see FIG. 1. The LI information may contain, depending of the intercepted SIP message, following information: GPRS domain target criterion, GPRS domain session identifiers, IMS domain user identities, IMS domain session identifiers, and/or LIID (Lawful Interception identifier) of the interception that found the IMS domain information.

The Mapping Function 4 may save the LI information into its internal cache for later use. The Mapping Function 4 of ADMF 3 may command the CSCF 11 over the X1_1 interface to start interception of IMS IRI using the resolved IMS domain user identity as IMS domain target criterion.

It is likely that SIP REGISTER message reaches the CSCF 11 before LI activation request is triggered by the method described above. Therefore it is essential that registration and session status of the user specified by the IMS domain target criterion is part of the LI activation response message or is sent with an explicit LI notification message to DF2 6.

This embodiment 6.) may be implemented using a technique wherein the DF3 9 or GSN 12 can parse out transport layer and application layer headers and extract information from them, such as described in PCT/IB03/05125. The LEMF 1 may be provided with IRI data on the LI target.

Embodiment 7.). This embodiment is shown in FIG. 3, and is similar to embodiment 6.), except that the Mapping Function 10 is located in the DF3 9. Thus the Mapping Function 4 of ADMF 3 is not needed.

Embodiment 8.). This solution is similar to embodiment 6.), except that the network function that performs the content of communication analysis is in the GSN 12 rather than DF3 9. If GSN 12 finds URL in the SIP header found in content of communications, it may forward the LI information to the Mapping Function 4 of ADMF 3 (FIG. 1) via the X1_1 interface. The other parts of the functionality of this embodiment 8.) are identical to that of embodiment 6.).

The below described embodiments 9.) and 10.) provide an activation of IMS interception initiated by GPRS based on mapping of GPRS identity to IMS identity.

Embodiment 9.). During the media reservation the media authorization is done between GGSN 22 and P-CSCF 23 (or more precisely PDF of P-CSCF). The media reservation is shown in FIG. 5.

The message flow and structure of FIG. 5 is similar to that of FIG. 4 so that the above description of FIG. 4 basically applies. Yet the messages 3., 4., and 6. are different in so far as in message 3. of FIG. 5 an additional LI information is sent to P-CSCF 23 in the COPS REQ message, and messages 4., 6. of FIG. 5 do not contain the LI information.

For the media reservation, the UE 20 sends Authorization Token in Activate PDP Context Request message 1 of FIG. 5. The SGSN 21 forwards the Authorization Token to GGSN 22 in Create PDP Context Request message 2. The Authorization Token represents the IMS domain session being created in IMS.

If there is an interception activated with GPRS domain target criterion this Authorisation Token can be exploited in starting the interception in IMS domain. When the GSN 12, or 21 or 22, notices an activation of PDP context related to GPRS domain target criterion, it reports the Authorization Token to the Mapping Function 4 of ADMF 3 over the X1_1 interface in a LI information message. LI information may consist of GPRS domain target criterion, GPRS domain session identifiers, lawful interception parameters, and/or IMS domain session identifiers (=Authorization Token). The Mapping Function 4 of ADMF 3 saves the information into an internal cache for later use.

If the internal cache already contains binding between Authorization Token and IMS domain user identity, the Mapping Function 4 of ADMF 3 may activate IMS domain interception in CSCF 11 over the X1_1 interface. If no hit is found the Mapping Function 4 of ADMF 3 may query the CSCF(s) 11 for the IMS domain user identity. The Mapping Function 4 sends a query message containing the Authorization Token to CSCF(s) 11 and expects to receive IMS domain user identity in a response message.

The Mapping Function 4 in ADMF 3 may receive IMS domain session identifiers also asynchronously from the CSCF 11 over the X_1 interface when the IMS domain session is started (session started with SIP INVITE method). The LI information related to IMS domain session may consist of IMS domain user identities, IMS domain session identifiers (e.g. ICID, Call-ID, Authorization Token) and/or GPRS domain session identifiers (e.g. GCID+GGSN address, TID) of the GPRS domain session related to the IMS domain session of the monitored user.

When the IMS domain user identity is known by Mapping Function 4 of ADMF 3, the ADMF 3 may command the CSCF(s) 11 to start interception in IMS domain.

Embodiment 10.) This embodiment is in accordance with FIG. 2, and is similar to the embodiment 9.), except that the Mapping Function 7 is located in DF2 6. It is the DF2 6 in this case that commands the CSCF 11 to start the interception in IMS domain.

Embodiment 11.). This embodiment provides an activation of IMS interception initiated by GPRS based on direct activation (Direct activation based GPRS initiated IMS interception activation solution). This embodiment is similar to embodiment 9.), except that no identifier mapping is done. No Mapping Function is thus needed. When ADMF 3 receives LI information from GSN 12 containing IMS domain session identifier(s), it uses them directly in IMS domain interception activation. That is, when the ADMF 3 receives IMS domain session identifier (e.g. Authorization Token) from the GSN 12 over the X1_1 interface, it may send LI activation to the CSCF 11 over the X1_1 interface. The LI information sent to CSCF 11 contains LI parameters (LIID, DF2 address, type of interception) and IMS domain session identifier (Authorization Token).

The below described embodiments 12.), 13.) provide an activation of IMS interception initiated by GPRS based on LI upload over Go interface.

Embodiment 12.). When GGSN 22 notices that a PDP context being created is monitored it may choose to add notification about LI in the COPS REQ message (like in message 3. of FIG. 5). The CSCF 11 or 23 may thus start interception of the IMS domain user identity associated with the PDP context (and therefore associated with GPRS domain user identity). LI information sent in the COPS REQ message 3. consists of LI parameters (LIID, DF2 address, type of interception) and IMS domain session identifier(s) (optionally GPRS domain target criterion and/or GPRS domain session identifiers).

LI information may be carried also in Create PDP Context Request message 2. sent by SGSN 21 to GGSN 22. This allows also SGSN 21 to trigger IMS domain IRI interception.

Embodiment 13.). This embodiment is similar to embodiment 12.), except that the COPS REQ message 3. from GGSN 22 to P-CSCF 23 (PDF) contains only an indication of need of interception. LI information sent in COPS REQ message 3. may consist of GPRS domain target criterion (IMSI, MSISDN, IMEI). The initial interception activation is done by ADMF 3 to all network elements using GPRS domain target criterion. In CSCF 11 the activation is in semi-active state. When the indication to intercept with the specific GPRS domain target criterion is received the interception changes its state to fully active. Activation responsibility is with ADMF like in embodiment 2.).

It should be understood that the above description and the accompanying figures are only intended to illustrate the present invention in a non-restrictive manner. Thus, the method and apparatus according to the present invention may also be used in other implementations or other cellular or non-cellular networks. As an example, instead of a SIP network a network based on another protocol such as H.323 may be used. The present invention is also applicable to a combination of e.g. CDMA2000 and IMS network. The invention may thus vary within the scope of the attached claims.

1. Method for intercepting at least one session involving at least a first network and a second network of different types, the method comprising:
monitoring signalling information, provided in at least one of the first and second networks, of the at least one session, and session content related to the same at least one session provided in another of the first and second networks;
wherein an indication to start interception is delivered between the first and second networks.

2. Method according to claim 1 wherein the step of monitoring signalling information comprises monitoring signalling information provided in an IP Multimedia Subsystem (IMS) network.

3. Method according to claim 1, wherein the step of monitoring session content comprises monitoring session content provided in a General Packet Radio Service (GPRS) network.

4. Method according to claim 1, wherein one of a network element and a function of the first network sends Lawful Interception (LI) information either directly to one of a support node of the second network, an Administration Function (ADMF), and a Delivery Function (DF).

5. Method according to claim 4, wherein said one of the network element and the function of the first network is a Control State Control Function (CSCF).

6. Method according to claim 4, wherein the ADMF is included in the signaling path and commands a support node of the second network to start the interception.

7. Method according to claim 4, wherein the LI information is sent from one of a Call State Control Function (CSCF) and a Policy Decision Function (PDF) of a CSCF to a General Packet Radio Service (GPRS) support node over one of a Go-interface and an X1_1-interface.

8. Method according to claim 4, wherein the LI information is sent during media authorization.

9. Method according to claim 4, wherein the LI information is sent to a Gateway General Packet Radio Service Support Node (GGSN) from a Proxy-Call State Control Function (P-CSCF).

10. Method according to claim 9, wherein, when the GGSN receives the LI information, it starts the interception of the content of communication related to the IP Multimedia Subsystem (IMS) session, and delivers the information to a Serving GPRS Support Node (SGSN) by attaching the LI information received from the P-CSCF to a Create PDP Context Response message, which the SGSN in turn starts the interception of content of communication related to the IMS session.

11. Method according to claim 10, wherein, in case of an inter-SGSN handover, the LI information is transferred from an old SGSN of a monitored user to a new SGSN.

12. Method according to claim 4, wherein an Administration Function (ADMF) performs actual interception activation in a Control State Control Function (CSCF) and a General Packet Radio Service Support Node (GSN) and sends the same LI information to these networks elements, wherein information on a need of interception is stored in the GSN, wherein one of the CSCF and a Policy Decision Function (PDF) of the CSCF includes only an indication of the interception need in the authorization decision.

13. Method according to claim 1, wherein the interception by the second network is activated by the first network using a Delivery Function 2 (DF2) wherein Lawful Interception (LI) information is sent from a Control State Control Function (CSCF) to the DF2 which then sends the LI information to a General Packet Radio Service Support Node (GSN).

14. Method according to claim 1, wherein the interception by the second network is activated by the first network based on mapping of an IP Multimedia Subsystem (IMS) identity to a General Packet Radio Service Support Node (GPRS) identity.

15. Method according to claim 1, wherein a Mapping Function is provided which translates target indications of the first network to corresponding target indications of the second network associated with a same monitored user.

16. Method according to claim 15, wherein the Mapping Function is provided in an Administration function (ADMF) which receives Lawful Interception (LI) information related to a session in the second network when the session is started.

17. Method according to claim 15, wherein the Mapping Function is provided in an Administration function (ADMF) which receives session identifiers of the first network when the session in the first network is started.

18. Method according to claim 15, wherein the Mapping Function is located in a Delivery Function 2, the Mapping Function commanding a network element of the second network to start interception.

19. Method according to claim 1, wherein the interception in the first network is activated based on an examination of content of communication (CC) of the second network.

20. Method according to claim 19, wherein an entity checks a message received from a support node of the second network for detecting Lawful Interception (LI) information, and forwards such information, if found, to a Mapping Function, the Mapping Function resolving the LI information to a user identity of the first network, wherein one of a network element and a function of the first network is commanded to start interception using the resolved user identity.

21. Method according to claim 20, wherein the Mapping Function is a Mapping Function of one of another network element and a function, the one of the another network element and the function commanding the one of the network element and the function of the first network to start interception using the resolved user identity.

22. Method according to claim 20, wherein the Mapping Function is located in a Delivery Function 3 (DF 3).

23. Method according to claim 20, wherein the entity is a Delivery Function.

24. Method according to claim 20, wherein the entity is a Support Node of the second network.

25. Method according to claim 1, wherein the interception in the first network is activated based on a mapping of an identity of a user used in the second network to an identity of the same user in the first network.

26. Method according to claim 25, wherein a media authorization is performed between the first and second networks, a User Equipment (UE) sends an Authorization Token to the second network which Authorization Token represents a session being created in the first network, the Authorization Token being reported to a Mapping Function in a Lawful Interception (LI) information message which includes a user identity used in the second network, the Mapping Function activating interception in the first network.

27. Method according to claim 26, wherein the Mapping Function is a Mapping function of an Administration Function (ADMF).

28. Method according to claim 26, wherein the Mapping Function is located in a Delivery Function 2 (DF2).

29. Method according to claim 25, wherein an Administration Function (ADMF) receives Lawful Interception (LI) information containing a session identifier used in the first network from a network element of the second network, the ADMF uses the session identifier directly for interception activation in the first network.

30. Method according to claim 1, wherein the interception in the first network is activated based on upload of Lawful Interception (LI) information from a network element of the second network.

31. Method according to claim 30, wherein the LI information is uploaded over a Go interface.

32. Method according to claim 1, wherein information of matching triggers of the first network is forwarded to the second network by using identities known in the second network.

33. Method according to claim 32, wherein the used identities are one of an International Mobile Subscriber Identity (IMSI) and a combination of a General Packet Radio Service (GPRS) Charging ID and a Gateway General Packet Radio Service Support Node (GGSN) identification.

34. Method according to claim 1, wherein the decision of interception is done for every session created in the first network.

35. Method according to claim 1, wherein the decision of interception issued for a session created in the first network is maintained in the first network after a termination of the session for use for at least one following session.

36. Method according to claim 1, wherein monitoring in the first network is activated by sending information to the first network when the interception is originally activated using target identifiers of the second network.

37. Method according to claim 36, wherein the target identifiers are one of an International Mobile Subscriber Identity (IMSI), a Mobile Subscriber ISDN Number (MSISDN), and an International Mobile Equipment Identity (IMEI).

38. System for intercepting at least one session involving at least a first network and a second network of different types, the system comprising:
means for monitoring signalling information, provided in one of the first and second networks, of the at least one session, and session content related to the same at least one session provided in another of the first and second networks; and
means for delivering an indication to start interception between the first and second networks.

39. System according to claim 38, wherein the first network is an IP Multimedia Subsystem (IMS) network.

40. System according to claim 38, wherein the second network is a General Packet Radio Service (GPRS) network.

41. System according to claim 38, wherein the first network comprises one of a network element and a function which is adapted to send Lawful Interception (LI) information through one of directly to a support node of the second network, to an Administration Function (ADMF) and to a Delivery Function (DF).

42. System according to claim 41, wherein said network element or function of the first network is a Call State Control Function (CSCF).

43. System according to claim 41, wherein the ADMF is included in a signaling path and is configured to command a support node of the second network to start the interception.

44. System according to claim 38, wherein the first network comprises one of a Call State Control Function (CSCF) and a Policy Decision Function (PDF), which is configured to send Lawful Interception (LI) information directly to a support node of the second network over a Go-interface.

45. System according to claim 38, comprising one of an Administration Function (ADMF), a Delivery Function 2 (DF2), and a Delivery Function 3 (DF3) which is configured to communicate with the first and second network.

46. System according to claim 45, wherein the one of the ADMF, the DF2, and the DF3 comprises a Mapping Function.

47. Network element to be used in a system according to claim 38, the network element comprising:
means for delivering an indication to start interception between the first and second networks.

48. Network element according to claim 47, further comprising at least one of a mapping function and a mediation function.

49. Network element according to claim 47, being implemented as one of an Administration Function (ADMF), a Delivery Function 2 (DF2) and a Delivery Function 3 (DF3) which is configured to communicate with the first and second networks.
